(19) United States
(12) Patent Application Publication
(10) Pub. No.: US 2023/0347944 A1
(43) Pub. Date: Nov. 2, 2023

(54) VEHICLE VIBRATION CONTROL SYSTEM, VEHICLE VIBRATION CONTROL METHOD, AND VEHICLE VIBRATION CONTROL PROGRAM

(71) Applicant: MITSUBISHI HEAVY INDUSTRIES ENGINEERING, LTD., Kanagawa (JP)

(72) Inventors: Akihisa KAWAUCHI, Tokyo (JP); Koji UCHIDA, Tokyo (JP); Hiroyuki KONO, Tokyo (JP); So TAMURA, Kanagawa (JP)

(21) Appl. No.: 17/799,513

(22) PCT Filed: Feb. 12, 2021
(86) PCT No.: PCT/JP2021/005293

§ 371 Date: Aug. 12, 2022

(30) Foreign Application Priority Data
Feb. 17, 2020 (JP) 2020-024425

(51) Int. Cl. B61F 5/24; B60G 17/016; B60G 17/0165; B60G 17/08

(52) U.S. Cl. CPC B61F 5/245; B60G 17/0161; B60G 17/0165; B60G 17/08; B60G 15/06

(57) ABSTRACT

A vehicle vibration control system includes: a buffer mechanism that is disposed between a wheel and a vehicle body and capable of adjusting buffer performance as a function of reducing vibration input to the vehicle body from the wheel; a weight detection unit that detects the weight of the vehicle body; a traveling position detection unit that detects the traveling position of the vehicle body; and a control device that controls the buffer performance of the buffer mechanism. The control device acquires a driving pattern in which the traveling position of the vehicle body and the buffer performance were set, on the basis of the weight of the vehicle body, and controls the buffer performance of the buffer mechanism on the basis of the acquired driving pattern and a result detected in the traveling position detection unit.

### TECHNICAL FIELD

The present disclosure relates to a vehicle vibration control system installed in a vehicle, a vehicle vibration control method, and a vehicle vibration control program.

### BACKGROUND ART

Vehicles such as railroad vehicles and automobiles include a vibration control device that buffers a vibration generated during traveling. As the vibration control device, there is a device that adjusts buffer performance to further suppress the vibration in accordance with a traveling state. According to the device disclosed in Patent Document 1, the vibration control device of the railroad vehicle is disclosed which includes a damping force variable damper interposed between a vehicle body and a bogie for supporting the vehicle body in the railroad vehicle to suppress the vibration of the vehicle body in a horizontal and lateral direction with respect to a traveling direction of the vehicle, and control means for controlling a control force for suppressing the vehicle body vibration generated by the variable damping force damper in a skyhook semi-active manner. The control means changes a skyhook damping coefficient, based on a traveling position of the vehicle.

### CITATION LIST

### Patent Document

[Patent Document 1] Japanese Unexamined Patent Application Publication No. 2007-131204

### SUMMARY OF INVENTION

### Technical Subject

As disclosed in Patent Document 1, the vibration can be suppressed by controlling a damping coefficient, based on the traveling position. However, in some cases, the vibration cannot be sufficiently suppressed by using the device disclosed in Patent Document 1. In addition, when a state of the traveling position is determined and controlled by using various sensors, a calculation load increases, and high-precision measurement is required by various sensors.

The present disclosure is made in view of the above-described circumstances, and aims to provide a vehicle vibration control system, a vehicle vibration control method, and a vehicle vibration control program which can more preferably reduce vibration of a vehicle body with a simple configuration.

### Subject to be Solved

In order to solve the above-described subject and to achieve an object, there is provided a vehicle vibration control system including a buffer mechanism disposed between a wheel and a vehicle body, and configured to adjust buffer performance which is a function to reduce a vibration input from the wheel to the vehicle body, a weight measurement unit that measures a weight of the vehicle body, a traveling position detection unit that detects a traveling position of the vehicle body, and a control device that controls the buffer performance of the buffer mechanism. The control device acquires a driving pattern in which the traveling position of the vehicle body and the buffer performance are set, based on the weight of the vehicle body. The buffer performance of the buffer mechanism is controlled, based on the acquired driving pattern and a result detected by the traveling position detection unit.

In order to solve the above-described subject and to achieve an object, there is provided a vehicle vibration control method for controlling buffer performance of a buffer mechanism disposed between a wheel and a vehicle body, and configured to adjust the buffer performance which is a function to reduce a vibration input from the wheel to the vehicle body. The vehicle vibration control method includes a step of measuring a weight of the vehicle body, a step of acquiring a driving pattern in which a traveling position of the vehicle body and the buffer performance are set, based on the weight of the vehicle body, a step of detecting the traveling position of the vehicle body, and a step of controlling the buffer performance of the buffer mechanism, based on the acquired driving pattern and a result obtained by detecting the traveling position.

In order to solve the above-described subject and to achieve an object, there is provided a vehicle vibration control program for controlling buffer performance of a buffer mechanism disposed between a wheel and a vehicle body, and configured to adjust the buffer performance which is a function to reduce a vibration input from the wheel to the vehicle body. The vehicle vibration control program executes a process including a step of measuring a weight of the vehicle body, a step of acquiring a driving pattern in which a traveling position of the vehicle body and the buffer performance are set, based on the weight of the vehicle body, a step of detecting the traveling position of the vehicle body, and a step of controlling the buffer performance of the buffer mechanism, based on the acquired driving pattern and a result obtained by detecting the traveling position.

### Advantageous Effects of Invention

According to at least one embodiment of the present disclosure, it is possible to more preferably reduce the vibration of the vehicle body with a simple configuration.

### BRIEF DESCRIPTION OF DRAWINGS

FIG. 1 is a schematic view illustrating a schematic configuration of a vehicle disposed on a guide track.

FIG. 2 is a side view illustrating a schematic configuration of the vehicle illustrated in FIG. 1.

FIG. 3 is a schematic view illustrating an example of a system for driving the vehicle.

FIG. 4 is a flowchart illustrating an example of a process executed by a vehicle vibration control system.

FIG. 5 is a flowchart illustrating an example of a process executed by the vehicle vibration control system.

FIG. 6 is a flowchart illustrating an example of a process executed by the vehicle vibration control system.

FIG. 7 is a flowchart illustrating an example of a process executed by the vehicle vibration control system.

### DESCRIPTION OF EMBODIMENTS

Hereinafter, some embodiments of the present disclosure will be described in detail with reference to the drawings. The present invention is not limited by the embodiments. In addition, configuration elements in the embodiments include those which can be easily replaced by those skilled in the art, or those which are substantially the same. Furthermore, the configuration elements described below can be appropriately combined with each other.

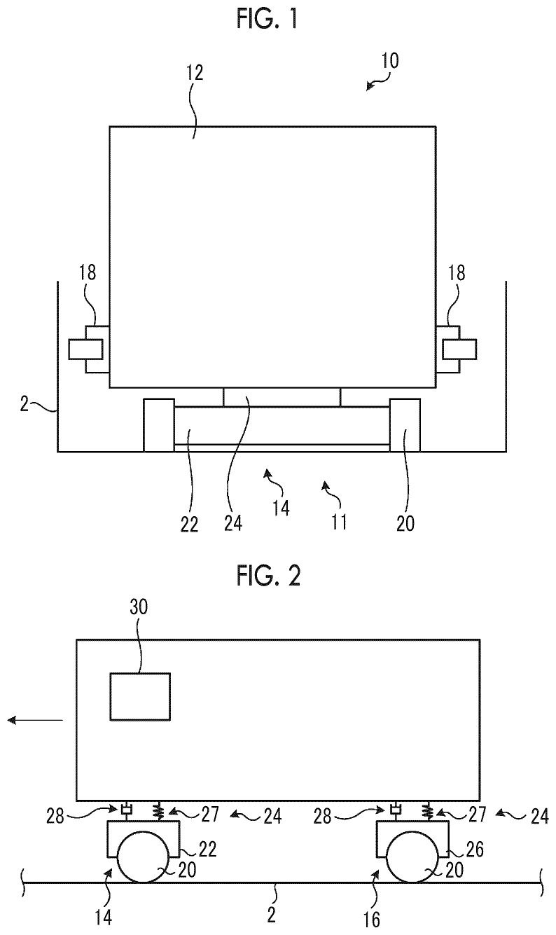

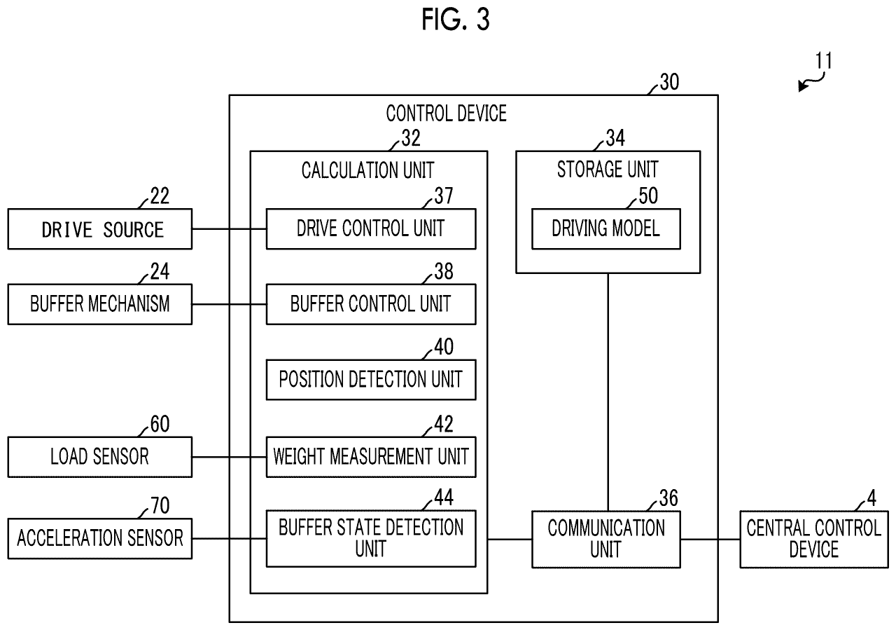

FIG. 1 is a schematic view illustrating a schematic configuration of a vehicle disposed on a guide track. FIG. 2 is a side view illustrating a schematic configuration of the vehicle illustrated in FIG. 1. FIG. 3 is a schematic view illustrating an example of a system for driving the vehicle. A vehicle 10 is a vehicle of an automated guideway type passenger transport system (Automated Guideway Transit) that travels on a guide track 2. The guide track 2 includes a road surface on which the vehicle travels and a side wall that regulates movement of the vehicle in a rightward-leftward direction. Driving of the vehicle 10 is controlled by a central control device 4. The central control device 4 communicates with a plurality of the vehicles 10, acquires information from the vehicles 10, and controls each operation of the vehicles 10. The vehicle may be provided with a function of the central control device 4, or the central control device 4 may be a separate body. A vehicle vibration control system 11 of the present embodiment includes a portion of the vehicle 10 and the central control device 4.

In the present embodiment, the vehicle of the automated guideway type passenger transport system will be described. However, the present embodiment is applicable to various vehicles including a buffer mechanism. For example, the present embodiment can be used for a train, a locomotive, or an automobile traveling on tracks. The vehicle is preferably applicable to the automated guideway type passenger transport system, the train, or the locomotive in which a traveling track is specified. In addition, the present embodiment is preferably applicable to autonomous driving.

As illustrated in FIGS. 1 and 2, the vehicle 10 includes a vehicle body 12, a drive unit 14, a driven unit 16, a guide unit 18, and a control device 30. In the present embodiment, the vehicle 10 is provided with the drive unit 14 and the driven unit 16, but only the drive unit 14 may be provided without providing the driven unit 16. In addition, the number of the drive units 14 and the driven units 16 is not particularly limited. In addition, in the vehicle 10, a plurality of the vehicle bodies 12 may be connected in a traveling direction. The vehicle body 12 is a housing for carrying a passenger or a cargo.

The drive unit 14 is fixed to a bottom surface of the vehicle body 12, and is disposed between the vehicle body 12 and a road surface of the guide track 2. The drive unit 14 includes a wheel 20, a drive source 22, and a buffer mechanism 24. The wheel 20 is a rubber tire, and is connected to the drive source 22. The drive source 22 is a power source for a rotational force of a motor. The drive source 22 rotates the wheel 20. The buffer mechanism 24 connects the drive source 22 and the vehicle body 12. The buffer mechanism 24 is provided with a buffer function that reduces a vibration input from the wheel 20 to the vehicle body 12. The buffer mechanism 24 has an elastic unit 27 and a damping unit 28. The elastic unit 27 is an elastic member such as a coil spring and a leaf spring. The damping unit 28 is a damping mechanism such as a hydraulic damper. The buffer mechanism 24 buffers the vibration in an upward-downward direction (vertical direction) which is input from the drive source 22 to the vehicle body 12 by connecting the drive source 22 and the vehicle body 12 to the elastic unit 27 and the damping unit 28, and buffers the vibration of the vehicle body 12 in the upward-downward direction. The buffer mechanism 24 is provided with an adjusting function to vary buffer performance including elastic performance of the elastic unit 27 and damping performance of the damping unit 28. The buffer mechanism 24 can adjust a function (vibration reduction amount with respect to a mode of the input vibration) to reduce the vibration input from the wheel 20 to the vehicle body 12 by adjusting an elastic coefficient of the elastic unit 27 that transmits the vibration and a damping coefficient of the damping unit 28 that damps the vibration. When the buffer mechanism 24 is provided with a function to reduce the vibration in addition to the elastic coefficient and the damping coefficient, a numerical value of the function may be changed so that the function to reduce the vibration can be adjusted.

The driven unit 16 is fixed to a bottom surface of the vehicle body 12, and is disposed between the vehicle body 12 and the road surface of the guide track 2. The driven unit 16 includes the wheel 20, a support unit 26, and the buffer mechanism (buffer device) 24. The wheel 20 is a rubber tire, and is connected to the support unit 26. The support unit 26 supports the wheel 20 to be rotatable. The buffer mechanism 24 connects the drive source 22 and the vehicle body 12. The buffer mechanism 24 has the same configuration as the buffer mechanism 24 of the drive unit 14.

The guide units 18 are respectively disposed on both side surfaces of the vehicle body 12. In the guide unit 18, rotatable wheels are disposed at facing positions on the side surfaces of the guide track 2. When the guide unit 18 is in contact with the side surface of the guide track 2, a tire rotates, and guides the vehicle body 12 to travel along the guide track 2 in the rightward-leftward direction.

Next, a relationship between a configuration of the control device 30 and each unit will be described with reference to FIG. 3. As illustrated in FIG. 3, the vehicle 10 includes a load sensor 60 and an acceleration sensor 70. The load sensor 60 measures a load of the vehicle body 12. The load sensor 60 measures a weight of the vehicle body 12 to measure a weight of a passenger riding on the vehicle body 12 and a cargo to be carried. The acceleration sensor 70 is mounted on the vehicle body 12, and measures acceleration input to the vehicle body 12. The acceleration sensor 70 of the present embodiment measures the acceleration in the vertical direction (upward-downward movement) of the vehicle body 12.

The control device 30 acquires various information from the load sensor 60, the acceleration sensor 70, and the central control device 4, and controls an operation of the drive source 22 and the buffer mechanism 24. The control device 30 includes a calculation unit 32, a storage unit 34, and a communication unit 36. The vehicle vibration control system 11 includes the buffer mechanism 24, the load sensor 60, the acceleration sensor 70, a drive control unit 37, a buffer control unit 38, a position detection unit 40, a weight measurement unit 42, and a buffer state detection unit 44, and the central control device 4.

The calculation unit 32 includes a calculation circuit such as a central processing unit (CPU), and performs various processes relating to traveling of the vehicle body 12 by the drive source 22 and control of the buffer performance of the buffer mechanism 24. The calculation unit 32 includes the drive control unit 37, the buffer control unit 38, the position detection unit 40, the weight measurement unit 42, and the buffer state detection unit 44. The drive control unit 37 controls rotation of the wheel 20 by the drive source 22, and controls acceleration or deceleration traveling of the vehicle 10. The buffer control unit 38 controls the buffer performance of the buffer mechanism 24. The drive control unit 37 and the buffer control unit 38 calculate various control conditions, based on a traveling position, reception, and a driving model 50, and execute the control.

The position detection unit 40 detects a position of the vehicle body 12. The position detection unit 40 calculates a movement distance, based on control information on the drive control unit 37, and detects a position with respect to a predetermined starting point, based on information on the guide track 2 and the movement distance. In addition, the position detection unit 40 may detect the position by using a positioning system such as a global positioning system (GPS). The weight measurement unit 42 acquires information on the weight of the vehicle body 12 from the load sensor 60. The buffer state detection unit 44 detects a state of the vibration in the upward-downward direction which acts on the vehicle body 12 from the acceleration sensor 70. Although the buffer state is detected by the acceleration sensor 70 in the present embodiment, the buffer state may be detected, based on the information acquired from the buffer mechanism 24 by the buffer control unit 38.

The storage unit 34 stores a software program (hereinafter, simply referred to as a program) and data which are used for processes of the calculation unit 32. The program may be stored in the storage unit 34, or may be recorded in a recording medium readable by the control device 30 which is a computer. In this case, the control device 30 includes a reading device for reading the program from the recording medium. In addition, the storage unit 34 stores the driving model 50 acquired via the communication unit 36. The driving model 50 stores data for controlling the drive source 22 and the buffer mechanism 24, based on an acceleration or deceleration movement pattern and the weight and the position of the vehicle body 12. A plurality of the driving models 50 are set in accordance with a traveling zone, the movement pattern, and the weight.

The communication unit 36 communicates with the central control device 4. A specific configuration example of the communication unit 36 includes a wireless communication device.

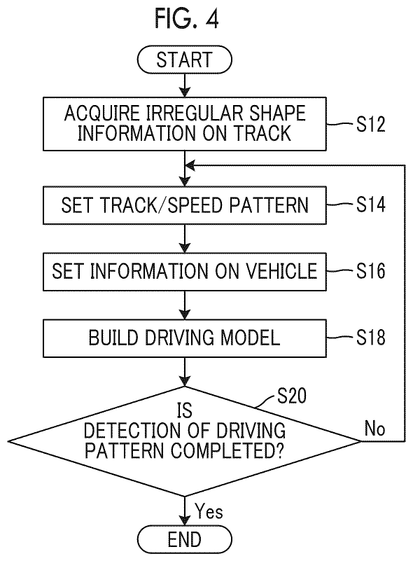

Next, a process executed by the vehicle vibration control system will be described with reference to FIGS. 4 to 7. FIGS. 4 to 7 are flowcharts illustrating an example of the processes respectively executed by the vehicle vibration control systems.

FIG. 4 is an example of a process for preparing a driving model. In the process illustrated in FIG. 4, the central control device 4 acquires information on the vehicle 10, and executes the process. The process may be executed by the control device 30. The central control device 4 acquires irregular shape information on the track (information on a traveling road surface) (Step S12). The irregular shape information on the track is acquired by measuring an irregular shape of a surface of the guide track 2. A camera or a sensor may be mounted on the vehicle 10 to acquire the information on the guide track 2, or the information may be acquired by other movement mechanisms. The information on the traveling road surface can include various information that affects the vibration during the traveling, in addition to the irregular shape information on the track.

The central control device 4 sets a track/speed pattern (Step S14). The central control device 4 sets a movement pattern when moving on the guide track 2. Specifically, movement speed, acceleration, and deceleration patterns are set, based on an inter-station movement time. The central control device 4 sets information on the vehicle (Step S16). As the information on the vehicle, the central control device 4 sets information on the weight of the vehicle, information on an adjustment range of the buffer performance of the buffer mechanism 24, and information on an adjustment speed.

The central control device 4 builds the driving model (Step S18). Based on the irregular shape of the road surface of the guide track 2 (information on the traveling road surface), the weight of the vehicle, and the movement pattern, a control condition of the drive unit and a control condition of the buffer performance of the buffer mechanism 24 at each position of the guide track 2 are set as the driving model.

The central control device 4 determines whether or not detection of the driving pattern is completed (Step S20). The driving pattern includes various driving models. When the central control device 4 determines that the detection of the driving pattern is not completed (No in Step S20), the central control device 4 returns to Step S14, and builds the driving model under a different condition. When the central control device 4 determines that the detection of the driving pattern is completed (Yes in Step S20), the central control device 4 completes this process.

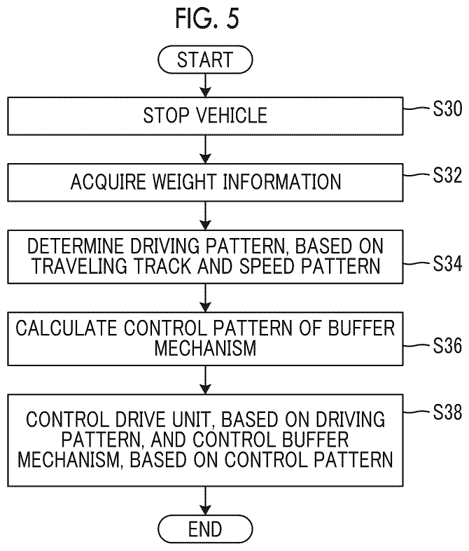

FIG. 5 is an example of control when the vehicle travels. The process in FIG. 5 is executed by each unit of the control device 30. In the control device 30, the vehicle 10 is stopped (Step S30). The vehicle 10 is stopped at a station, and the number of passengers riding on the vehicle body 12 and a cargo are changed, and the weight is changed. The control device 30 acquires weight information (Step S32). The control device 30 causes the weight measurement unit 42 to acquire the weight before departure.

The control device 30 determines the driving pattern, based on the traveling track and the speed pattern (Step S34). Specifically, the control device 30 selects a driving model from the driving pattern, based on the detected weight, the traveling zone, and the traveling speed pattern. The control device 30 may extract an approximate driving model, and further corrects the driving model, based on conditions. The control device 30 calculates a control pattern of the buffer mechanism (Step S36). The control device 30 calculates the buffer performance of the buffer mechanism at each position in the traveling zone, based on the driving model.

The control device 30 controls the drive unit, based on the driving pattern, and controls the buffer mechanism, based on the control pattern (Step S38). The control device 30 causes the position detection unit 40 to detect a position, and controls each unit to have a drive force of the drive unit which is set at each position, and the buffer performance of the buffer mechanism 24, based on the detected position and the driving pattern.

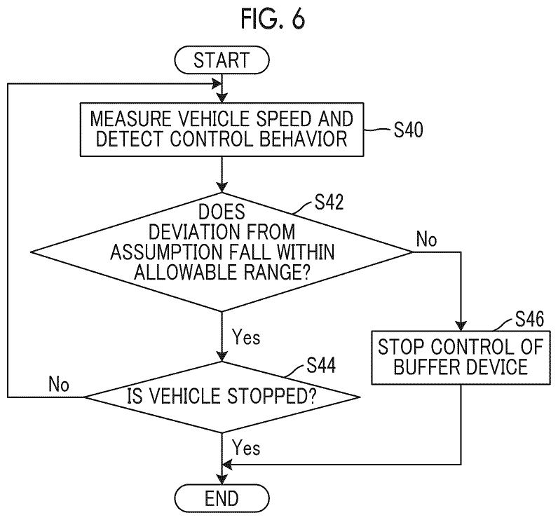

FIG. 6 is a control executed when the vehicle 10 travels. The process in FIG. 5 is executed by each unit of the control device 30. The control device 30 measures a vehicle speed, and detects a control behavior (Step S40). The control device 30 measures the vehicle speed, and detects a vibration state of the vehicle at each position. In the present embodiment, the buffer state detection unit 44 detects a buffer state, based on the information detected by the acceleration sensor 70.

The control device 30 determines whether or not a deviation from an assumption falls within an allowable range (Step S42). That is, it is determined whether a difference between the detected information and a behavior assumed based on the driving model falls within the allowable range. Specifically, the speed during the traveling and the vibration during the traveling are detected. The vibration during the traveling may be detected by the acceleration sensor 70, or may be detected from a state of the buffer mechanism 24. When the control device 30 determines that the deviation does not fall within the allowable range (No in Step S42), that is, the deviation is equal to or greater than the allowable range, the control device 30 stops the control of the buffer device (Step S46). That is, the control device 30 does not change the buffer performance as a fixed value. The control device 30 fixes the buffer performance until the vehicle 10 is stopped.

When the control device 30 determines that the deviation falls within the allowable range (Yes in Step S42), the control device 30 determines whether the vehicle is stopped (Step S44). When the control device 30 determines that the vehicle is not stopped (No in Step S44), the control device 30 returns to Step S40. That is, the control device 30 repeats the processes in Steps S40 to S44 until the vehicle is stopped. When the control device 30 determines that the vehicle is stopped (Yes in Step S44), the control device 30 completes this process.

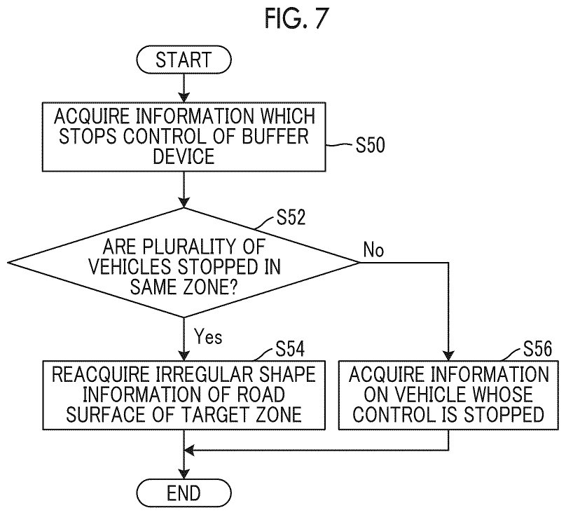

FIG. 7 is an example of a process executed by the vehicle vibration control system 11. In FIG. 7, the process is executed by the central control device 4. The central control device 4 acquires information which stops the control of the buffer device (Step S50). The central control device 4 determines whether or not a plurality of vehicles are stopped in the same zone (Step S52). When the central control device 4 determines that the plurality of vehicles are stopped in the same zone (Yes in Step S52), the central control device 4 reacquires the irregular shape information on a road surface of a target zone (Step S54), and completes this process. When the central control device 4 determines that the plurality of vehicles are not stopped in the same zone (No in Step S52), the central control device 4 acquires the information on the vehicle whose control is stopped (Step S56), and completes this process. Specifically, the buffer performance of the buffer mechanism 24 of the vehicle whose control of the buffer device is stopped is maintained.

As in the present embodiment, the vehicle vibration control system 11 sets the driving model corresponding to the weight, the position, and traveling information, and controls the buffer performance of the buffer mechanism 24, based on the weight and position. In this manner, the buffer performance can be controlled by detecting the weight and position information. Specifically, the control can be executed with a smaller processing amount, compared to control executed for feedback control by detecting the vibration during the traveling or control executed for feedforward control by detecting the irregular shape during the traveling. In addition, the present embodiment is applicable to various vehicles 10 traveling on the guide track 2. In addition, the control is executed, based on the driving model. Accordingly, the vibration of the vehicle body 12 during the traveling can be preferably suppressed by active control or semi-active control.

When a difference between the speed during traveling and a value calculated based on the driving model is great, the vehicle vibration control system 11 controls the buffer performance by stopping the control of the buffer performance of the buffer mechanism 24. In this manner, it is possible to suppress a possibility that the vibration of the vehicle body 12 may be amplified. In this manner, the vehicle body 12 can be further stabilized.

The vehicle vibration control system 11 is provided with the buffer state detection unit 44, and detects the vibration of the vehicle body 12. When a difference between the vibration during traveling and a value calculated based on the driving model is great, the buffer mechanism 24 controls the buffer performance by stopping the control of the buffer performance of the vehicle. In this manner, it is possible to suppress a possibility that the vibration of the vehicle body 12 may be amplified. In this manner, the vehicle body 12 can be further stabilized.

When the control executed by the buffer control unit 38 is stopped, and when the plurality of vehicles 10 are stopped in the stopping zone, the vehicle vibration control system 11 detects the irregular shape of the corresponding zone again. In this manner, the driving model can be maintained in a suitable state. In addition, when the control executed by the buffer control unit 38 is stopped, and when the plurality of vehicles 10 are not stopped in the stopping zone, the vehicle vibration control system 11 maintains the performance of the buffer mechanism 24 of the corresponding vehicle 10. In this manner, it is possible to repair a deviation occurring in the vehicle 10.

When the acceleration sensor 70 is installed as in the present embodiment, it is preferable that the vehicle vibration control system 11 detects the buffer state by the acceleration sensor 70 when the driving model is prepared, for example, when the irregular shape is measured, and calculates the driving model including the detected result. In this manner, the driving model can be prepared, based on a response of the buffer device during actual traveling, in addition to the calculated value. In addition, in this case, the measurement result of the acceleration sensor 70 may be used to execute the control using skyhook control. A value of the executed control and a vibration state may be detected. The detected information may be used to calculate the driving model. In the vehicle vibration control system 11, the driving model calculated by using the result detected by the acceleration sensor 70 is applicable to a vehicle which does not include the acceleration sensor. That is, the acceleration sensor 70 may be installed only in a vehicle which collects information for calculating the driving model. In this manner, the number of sensors installed in the vehicle 10 can be further reduced.

In addition, in the above-described embodiment, the acceleration sensor 70 is used in the vehicle 10 to detect the vibration of the vehicle body 12. However, the vibration in the upward-downward direction of the vehicle may be detected, based on information on the drive unit and position information on the buffer mechanism 24 which is acquired when the buffer mechanism 24 is controlled (elasticity of the elastic unit 27, position information on the damping unit 28, and pressure information). In this manner, the process can be executed without using the acceleration sensor in the control during traveling.

The embodiment is presented as an example, and is not intended to limit the scope of the invention. The embodiment and the modification example can be implemented in various other forms, and various omissions, substitutions, and modifications can be made within the scope not departing from the concept of the invention. The embodiment and the modification example are included in the scope and the concept of the invention as well as in the scope of the appended claims and an equivalent scope thereof.

### REFERENCE SIGNS LIST

2 Guide track
4 Central control device
10 Vehicle
11 Vehicle vibration control system
12 Vehicle body
14 Drive unit
16 Driven unit
18 Guide unit
20 Wheel
22 Drive source
24 Buffer mechanism
26 Support unit
27 Elastic unit
28 Damping unit
30 Control device
32 Calculation unit
34 Storage unit
36 Communication unit
37 Drive control unit
38 Buffer control unit
40 Position detection unit
42 Weight measurement unit
44 Buffer state detection unit
50 Driving model
60 Load sensor
70 Acceleration sensor

1. A vehicle vibration control system comprising:
a buffer mechanism disposed between a wheel and a vehicle body, and configured to adjust buffer performance which is a function to reduce a vibration input from the wheel to the vehicle body;
a weight measurement unit that measures a weight of the vehicle body;
a traveling position detection unit that detects a traveling position of the vehicle body; and
a control device that controls the buffer performance of the buffer mechanism,
wherein the control device acquires a driving pattern in which the traveling position of the vehicle body and the buffer performance are set, based on the weight of the vehicle body, and
the buffer performance of the buffer mechanism is controlled, based on the acquired driving pattern and a result detected by the traveling position detection unit.

2. The vehicle vibration control system according to claim 1,
wherein the driving pattern is information in which the buffer performance of the buffer mechanism that buffers the vibration of the vehicle body is set for each position, based on information on a traveling road surface of the vehicle body, the weight of the vehicle body, and a traveling speed.

3. The vehicle vibration control system according to claim 1,
wherein the traveling position detection unit calculates a position, based on data of a drive unit that moves the vehicle body.

4. The vehicle vibration control system according to claim 1, further comprising:
a communication unit that communicates with an external device,
wherein the control device outputs information on the weight of the vehicle body by using the communication unit, and acquires the information.

5. The vehicle vibration control system according to claim 1,
wherein the buffer mechanism includes an elastic unit that generates an elastic force and a damping unit that generates a damping force.

6. The vehicle vibration control system according to claim 1,
wherein the control device has a buffer state detection unit that detects a buffer state of the vehicle body, and
when a difference between the detected buffer state and a state set in the driving pattern is equal to or greater than a threshold value range, the buffer state detection unit stops control of the buffer mechanism.

7. The vehicle vibration control system according to claim 6,
wherein the buffer state detection unit calculates the buffer state, based on a detection value of an acceleration sensor that detects acceleration of the vehicle body.

8. The vehicle vibration control system according to claim 6,
further comprising:
a central control device that acquires information from the control device,
wherein when there are two or more vehicles that stop the control of the buffer mechanism in the same zone, information on a road surface in the same zone is reacquired, and
when there is a single vehicle that stops the control of the buffer mechanism in the same zone, a state of the vehicle body is inspected.

9. A vehicle vibration control method for controlling buffer performance of a buffer mechanism disposed between a wheel and a vehicle body, and configured to adjust the buffer performance which is a function to reduce a vibration input from the wheel to the vehicle body, the method comprising:
a step of measuring a weight of the vehicle body;
a step of acquiring a driving pattern in which a traveling position of the vehicle body and the buffer performance are set, based on the weight of the vehicle body;
a step of detecting the traveling position of the vehicle body; and
a step of controlling the buffer performance of the buffer mechanism, based on the acquired driving pattern and a result obtained by detecting the traveling position.

10. A non-transitory computer-readable recording medium storing a vehicle vibration control program for controlling buffer performance of a buffer mechanism disposed between a wheel and a vehicle body, and configured to adjust the buffer performance which is a function to reduce a vibration input from the wheel to the vehicle body, the program executing a process comprising:
a step of measuring a weight of the vehicle body;
a step of acquiring a driving pattern in which a traveling position of the vehicle body and the buffer performance are set, based on the weight of the vehicle body;
a step of detecting the traveling position of the vehicle body; and
a step of controlling the buffer performance of the buffer mechanism, based on the acquired driving pattern and a result obtained by detecting the traveling position.
